(19) United States
(12) Patent Application Publication
(10) Pub. No.: US 2025/0282499 A1
(43) Pub. Date: Sep. 11, 2025

(54) UNMANNED HELICOPTER FOR DELIVERING BLOOD PRODUCT TO A TARGET LOCATION

(71) Applicant: Fenwal, Inc., Lake Zurich, IL (US)

(72) Inventors: James Madsen, Chicago, IL (US); Kyungyoon Min, Kildeer, IL (US); Thomas Gniadek, Deerfield, IL (US); Kyle Betancourt, Fox Lake, IL (US); Matthew Breunig, Germantown, WI (US); Haley Hovland, Burlington, WI (US); Jeannette Wu, Minneapolis, MN (US)

(73) Assignee: Fenwal, Inc., Lake Zurich, IL (US)

(21) Appl. No.: 18/863,733

(22) PCT Filed: May 10, 2023
(86) PCT No.: PCT/US2023/021776

§ 371 Date: Nov. 7, 2024

Related U.S. Application Data
(60) Provisional application No. 63/340,310, filed on May 10, 2022.

(51) Int. Cl. B64U 10/16; B64U 101/55; B64U 101/67

(52) U.S. Cl. CPC B64U 10/16; B64U 2101/55; B64U 2101/67; B64U 2201/20

(57) ABSTRACT

An unmanned helicopter system and method for delivering a blood product to a target includes a body, a plurality of spinning rotors, each rotor comprising at least one propeller, and a cord coupled to a container configured to contain a blood product. A drop mechanism lowers the cord and blood product and resists gravitational acceleration of the container during at least a portion of a descent of the container. A control circuit navigates the helicopter to the target location and, while airborne, receives a command to deliver the blood product. The control circuit, in response to receiving the command, controls the drop mechanism to lower the cord and container containing the blood product to the target location.

### CROSS-REFERENCE TO RELATED PATENT APPLICATIONS

The present application claims the benefit of and priority to Provisional Application No. 63/340,310 filed on May 10, 2022, the entire disclosure of which is incorporated by reference herein.

### BACKGROUND

The present application relates to rapidly delivering viable blood products to remote locations where blood supply is not readily available.

Many people live in rural areas, some more than 10 miles from the nearest hospital. These people may not have immediate access to a blood supply in emergencies. Upon receiving a blood delivery request, a driver picks up blood from a blood bank and drives the units to the rural patient site. Ground transportation of blood can take many hours or even days depending on the roads.

In a military setting, exsanguination accounts for a large percentage of potentially survivable deaths occurring before soldiers can receive treatment. On the battlefield, some medics will carry blood kits including whole blood for transfusion to administer to wounded soldiers. But it is not feasible to carry a large number of blood units needed to prevent exsanguination.

### BRIEF DESCRIPTION OF THE DRAWINGS

FIG. 1 is a block diagram of an unmanned helicopter for delivering a blood product to a target location, according to an illustrative embodiment;

FIG. 2 is a set of diagrams illustrating a system and method of dropping a blood container to a target site, according to an illustrative embodiment;

FIG. 3 is a flow diagram of a system and method for delivering a blood product to a target using an unmanned helicopter, according to an illustrative embodiment;

FIG. 4 is a photograph of an unmanned helicopter delivering a container to a target location; according to an illustrative embodiment; and

FIGS. 5 and 6 are a set of diagrams illustrating a system and method for delivering a blood product to a target using an unmanned helicopter, according to an alternative embodiment; is a data diagram illustrating the generation of a request message having certain fields, according to an illustrative embodiment.

### DETAILED DESCRIPTION OF ILLUSTRATIVE EMBODIMENTS

In some embodiments, a system and method are provided to deliver blood products along with transfusion material to remote rural locations far from hospitals or directly to battlefield medics to save wounded soldiers.

In some embodiments, blood products are rapidly transported via drone and slowly lowered or dropped to onsite medical personnel to administer to patients.

In some embodiments, rapid blood supply can be provided to rural areas or to the battlefield through the use of an unmanned aerial drone, onboard temperature control, vibration mitigation, and/or slow, controlled delivery from the drone to the ground personnel.

In some embodiments, rural or remote areas may have access to a wider variety of blood products.

In some embodiments, the drone flight path can be programmed to deliver blood products directly to GPS coordinates of the requesting personnel. Upon arriving onsite, the drone can either automatically drop the blood products or alternatively hover and wait for the requesting personnel to send a signal (e.g., a wireless transmission, a wave which is detected by an onboard camera, etc.) to the drone to drop the products. This release signal from the personnel could be in the form of a coded signal via radio frequency.

In some embodiments, personnel at a target site could request any number and type of blood products to be delivered directly to their GPS coordinates without waiting for a land-based vehicle, or even in cases where land-based vehicles cannot easily reach the patient in need.

In some embodiments, use of a tailless helicopter device allows a more precise delivery and a more controlled drop than use of an airplane having a tail.

In some embodiments, onsite personnel may request any number and type of blood products to be delivered directly to their GPS coordinates without waiting for a land-based vehicle. In some embodiments, blood products may be delivered to areas having patients in need that are not reachable by land-based vehicles.

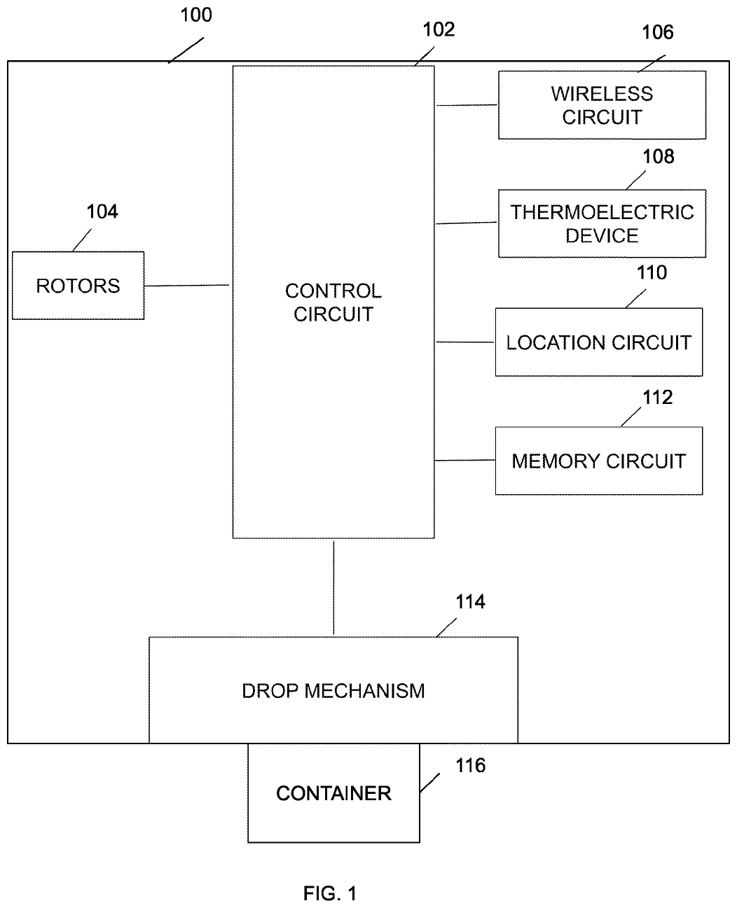

Referring now to FIG. 1, a block diagram of an unmanned helicopter for delivering a blood product to a target location will be described, according to an exemplary embodiment. The unmanned helicopter may be a rotorcraft in which lift and/or thrust are supplied by spinning rotors which spin horizontally and/or on an adjustable plane. The unmanned helicopter may be configured to navigate autonomously according to a navigation algorithm and/or by way of remote control from a human operator. The unmanned helicopter may be a miniature unmanned aerial vehicle (UAV) or small UAV weighing more than about two kilograms and/or less than about 25 kilograms. The unmanned helicopter may be a medium-sized UAV weighing more than about 25 kilograms and/or less than about 150 kilograms. The unmanned helicopter may be a large-sized UAV weighing more than about 150 kilograms.

The unmanned helicopter may comprise a body 100 which may be tailless and rotors 104 which may comprise at least four spinning rotors, each rotor comprising a propeller. The unmanned helicopter may comprise at least six rotors, at least eight rotors, or more rotors, each rotor comprising a propeller. Rotors 104 may be driven by one or more motors, such as an electric motor, an internal combustion engine, a jet engine, etc. An onboard power source, such as battery, such as a lithium-polymer battery may be used by the motor(s). In an alternative embodiment, a hydrogen fuel cell or gasoline may provide energy. In one embodiment, at least two batteries providing at least 20,000 mAh may be used. In one embodiment, the unmanned helicopter may be configured to carry at least 10 pounds, at least 20 pounds, or other weights in addition to the weight of its own components.

A control circuit 102 may be disposed in or on the housing and configured to perform the operations described herein. Control circuit 102 may comprise analog and/or digital circuit components forming one or more processing circuits configured to perform the operations described herein. The processing circuits may comprise discrete circuit elements and/or programmed integrated circuits, such as one or more microprocessors, microcontrollers, analog-to-digital converters, application-specific integrated circuits (ASICs), programmable logic, printed circuit boards, and/or other circuit components. Control circuit 102 may be coupled to a network interface circuit, such as a wireless circuit 106 configured to provide communications over one or more networks. The network interface circuit may comprise digital and/or analog circuit components configured to perform network communications functions. The networks may comprise one or more of a wide variety of networks, such as wired or wireless networks, wide area-local-area or personal-area networks, proprietary or standards-based networks, etc. The networks may comprise networks such as networks operated according to Bluetooth protocols, IEEE 802.1 1x protocols, cellular (TDMA, CDMA, GSM) networks, or other network protocols. Wireless circuit 106 may be configured for communication on one or more of these networks and may be implemented in one or more different sub-circuits, such as network communication cards, internal or external communication modules, etc.

A location circuit 110 may be provided for performing navigation functions, such as receiving signals from global positioning system satellites, cellular network towers, Wi-Fi routers, or other devices. Location circuit 110 may be configured to determine a location of the unmanned helicopter and/or provide the location to control circuit 102. Control circuit 102 and/or location circuit 110 may be configured to navigate the helicopter to a target location which is programmed into control circuit 102 (e.g., by receiving it from wireless circuit 106) and stored in memory circuit 112.

Memory circuit 112 may be in communication with control circuit 102 and/or may be a part of control circuit 102. Memory circuit 112 may comprise a tangible computer readable medium comprising any type of computer readable storage. The term tangible computer readable medium excludes propagating signals. Memory circuit 112 may store algorithms to implement processes described herein using coded instructions (e.g., computer readable instructions) stored on a non-transitory computer readable medium such as a hard disk drive, a flash memory, a read-only memory, a cache, a random-access memory and/or any other storage media in which information is stored for any duration (e.g., for extended time periods, permanently, brief instances, for temporarily buffering, and/or for caching of the information). Memory circuit 112 may include any desired type of volatile and/or non-volatile memory such as, for example, static random access memory (SRAM), dynamic random access memory (DRAM), flash memory, read-only memory (ROM), etc.

In some embodiments, a thermoelectric device 108 may be provided. The thermoelectric device may be controlled by control circuit 102 and/or by a separate control circuit and may be configured to use electrical energy (e.g., from a battery) to control a temperature of a blood product being carried by the unmanned helicopter. The thermoelectric device may comprise a Peltier effect device or other device configured to provide a thermoelectric effect to convert electrical energy to a temperature difference. For example, thermoelectric device 108 may be configured to keep a blood product within container 116 between about 3 degrees C. and about 30 degrees C. In another embodiment, thermoelectric device 108 may be configured to maintain a temperature of a blood product within container 116 at less than 4 degrees C. during at least a portion of a trip navigated by the unmanned helicopter. Thermoelectric device 108 may comprise or be in communication with a temperature sensor disposed within container 116, on container 116, on a blood product within container 116, or in other places to monitor the temperature of the container, a portion of the container, or the blood product within the container. In alternative embodiments, other temperature control devices may be provided, such as ice or foam ice packs, Styrofoam packaging, etc.

A drop mechanism 114 may be coupled to body 100 and/or under control of control circuit 102. The drop mechanism may be configured to lower a cord coupled to a container containing a blood product and to resist gravitational acceleration of the container during at least a portion of a descent of the container. Control circuit 102 may be configured to navigate the helicopter to the target location using target location data (e.g., geographic coordinates, etc.) and current location data from location circuit 110. While airborne, control circuit 102 may be configured to receive a command to deliver the blood product. The command may be received via wireless circuit 106 from a command station remote from the target location or from a transmitter disposed at or near (e.g., within 10 meters of, within 50 meters of, etc.) the target location. Control circuit 102 may, be configured to, in response to receiving the command, control drop mechanism 114 to lower the cord and container containing the blood product to the target location.

The cord (not shown in FIG. 1) may comprise any length and gage of a string, rope, cable, etc. whether twisted-fiber or single-fiber, or other cord-like device. The cord may be attached to drop mechanism 114 on one end and attached to container 116 on another end. The cord may have two opposite ends, both of which ends are left at the target location when the blood product is delivered to the target location. Alternatively, the cord may be raised by drop mechanism 114 after delivery (with or without the attached container) and returned to a base station for reuse of the cord and/or container.

In some embodiments, a vibration mitigation device may be provided. The vibration mitigation device may comprise a piece of foam or a sponge pad disposed between a bottom of container 116 and a blood product disposed therein. Alternatively, one or more springs may be provided in a bottom of container 116 to cushion an impact of container 116 when it is lowered to the ground.

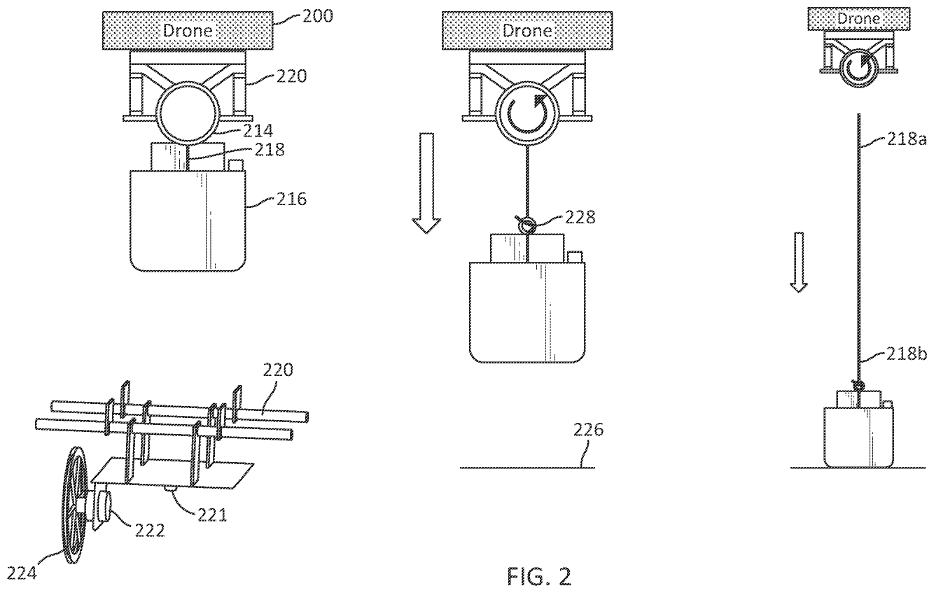

Referring now to FIG. 2, systems and methods of dropping a blood container to a target site will be described. An unmanned helicopter or drone 200 is shown having a drop mechanism 214 comprising a bracket 220 attached to drone 200. Bracket 220 may be coupled to drone 200 using any of a number of different fasteners, such as screws, rivets, latches, an interference fit, welds, etc. In this particular embodiment, bracket 220 comprises a plurality of parallel pipes or rods with associated fasteners for attaching to drone 200. A plate hangs beneath the rods. A cord 218 is wrapped around a pulley 224 and is attached to container 216 configured to hold one or more blood products. A speed limiter 222 is coupled to the plate and configured to slowly rotate pulley 224 under a force of gravity pulling on container 216 and cord 218. In one embodiment, speed limiter 222 comprises a speed dampening mechanism configured to covert rotational force on pulley 224 to frictional energy. A rotary damper having a maximum rotations per minute and/or a maximum rotation speed may be used. Exemplary speed limiters could be FRT-K2-502, FRT-K2-103, FRT-K2-203, FRT-K2-303, or FRT-K2-403 manufactured by ACE Controls Inc., Farmington Hills, Michigan. In one embodiment, speed limiter 222 is configured to resist tension on cord 218 caused by gravitational acceleration of container 216 during at least a portion of a descent of the container. For example, speed limiter 222 may be configured to slow a speed of travel of container 216 to a speed slower than a speed that container 216 would travel under a force of gravity. Speed limiter 222 may be configured to reduce the speed of travel during a first portion, a middle portion, and/or an end portion of the descent from drone 200 to a target area 226 (e.g., a ground, building, vehicle, etc.). By reducing a speed of travel, speed limiter 222 may reduce an impact force upon container 216 and the blood product therein when container 216 reaches target area 226, thereby reducing a risk of hemolysis. Speed limiter 222 may be an active component, providing a motor force to cord 218. Speed limiter 222 may be a passive component which is not powered but instead provides resistance to the lowering of cord 218. In an embodiment in which speed limiter is an active component, speed limiter 222 may be comprise a motor configured to rotate pulley 224 at a predetermined speed and/or acceleration according to an algorithm stored in memory circuit 112. For example, control circuit 102 may be configured to lower cord 218 at a first speed for a first portion of the descent of the container and a second, slower speed for a second or final portion of the descent of the container. In this embodiment, the container may be lowered more quickly but still provide a soft landing for container 218.

A release element 221 may be disposed on bracket 220 which is controllable by control circuit 102 to release container 216. Release element 221 may be a controllable latch that is coupled to a hook 228 mounted to container 216. Control circuit 102 may be configured to send a signal to release element 221 to move the latch out from hook 228 to release container 216.

Cord 218 may comprise a first end 218a and a second end 218b. In one embodiment, both ends 218a,b are lowered to the target area under a force of gravity. In this embodiment, end 218a would not be fixed to the drone and would simply fall away along with delivered product products.

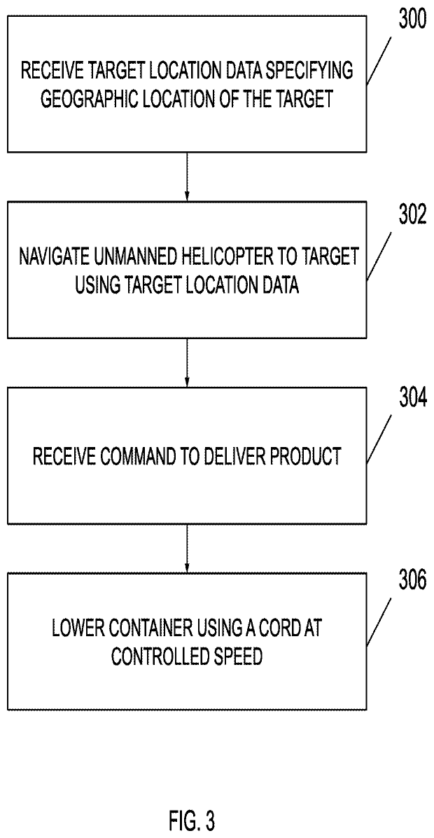

Referring now to FIG. 3, a method of method of delivering a blood product to a target using an unmanned helicopter will be described. At a block 300, an unmanned helicopter is configured to receive target location data specifying a geographic location of the target. The target location data may be transmitted from a base station or control tower for a fleet of unmanned helicopters. The target location data may be received over a wireless signal, such as a cellular network. In some cases, the target location can be transmitted from a person's mobile phone at the target location through a cellular or other communication network to the unmanned helicopter. The target location may comprise geographic coordinates for the target location. Alternatively, other spatial reference system coordinates may be used in alternate embodiments. In some embodiments, the unmanned helicopter may be able to detect a wireless transmission from a transmitter at the target location and, for at least a portion of the navigation, use a signal strength detector to follow the transmission to its origination point. A location beacon could be used which transmits the location beacon's GPS location to the drone via cellular network or another network. The drone may be configured with an algorithm and built-in network connectivity to automatically fly toward the beacon when approaching an end of its flight.

At a block 302, the unmanned helicopter is configured to navigate to the target using the target location data. In one example, the target location is expressed in geographic coordinates and the unmanned helicopter may use a Global Positioning System receiver to generate a current location. The control circuit is then configured to drive the spinning rotors of the unmanned helicopter to navigate the helicopter from its current location to the target location. Upon arrival at the target location, the helicopter may be configured to adjust (typically lower) its altitude to a predetermined altitude that is within a drop range of the helicopter defined, for example, based on a length of the cord. The helicopter may be configured to vary its speed, altitude, and path based on various factors, such as weather, obstacles, or other threats to the safe passage of the helicopter. The route may be calculated at a base station and transmitted to the helicopter or calculated at the helicopter using an onboard geographic information system database. The route may further be adjusted during the navigation by a human operator at a base station or otherwise remote from the helicopter to account for various inputs, such as weather changes, drifting off course, change in priority of target location, etc.

At a block 304, the unmanned helicopter is configured to receive a command to deliver the blood product. When the helicopter has arrived at or near the target location and at or near predetermined altitude, the helicopter may await a signal before lowering the container. In an alternative embodiment, the helicopter may begin lowering the container without awaiting a signal. The signal may be transmitted from a base station or control station remote from the target location (e.g., at least several hundred meters away) by a human operator. The signal may be transmitted from a person at or near the target geographic location, for example using an application operating on a smartphone or other handheld device. When the person sees the drone in a good location for the drop, the user may press a button or speak into the phone to send the signal wirelessly from the phone to the helicopter. In response to receiving the signal, the helicopter may begin lowering the container using the cord at one or more controlled speeds. (Block 306). The speed may be controlled by a passive speed limiter, an active motor assembly, or other drop mechanism.

In one embodiment, the method may further comprise controlling a temperature of the container with a thermoelectric device configured to use electrical energy. The electrical energy may be provided by a battery. The temperature may be controlled by the control circuit of the helicopter and/or a separate control circuit disposed in the container configured to sense a temperature of the container, air within the container, and/or the blood product container and to control the thermoelectric device to cool and/or warm the area surrounding the thermoelectric device to control to a target temperature or target temperature range. In one example, the method comprises maintaining the temperature to less than 4 degrees C. during at least a portion of the navigating.

In one embodiment, the method further comprises lowering both ends of the cord to the target with the container.

In one embodiment, the blood product may be lowered at a speed less than about 1.4 meters per second for at least half of a distance, at least one quarter of the distance, or at least one eighth of the distance from the unmanned helicopter to the target location.

In one embodiment, the method may further comprise sensing forces imposed on the container and storing the sensed forces in a memory circuit in the unmanned helicopter. The forces may be attributable to an impact of the container on the ground after lowering, to vibration, to wind pushing against the container during flight, or attributable to other causes. The force data may then be retrieved and analyzed to improve aspects of the system from vibration control to navigation route to descent speeds and/or durations. In some embodiments, the method may comprise monitoring temperatures within the compartment during at least a portion of the navigating and storing the monitored temperatures in the memory circuit in the unmanned helicopter.

In some embodiments, the lowered container may comprise a plurality of blood product containers (e.g., at least two packs of whole blood, red blood cells, plasma, platelets, etc.). The lowered container may further comprise disposable transfusion materials such as gauze, needles, tubing sets, disposable components, tape, administration devices, etc.

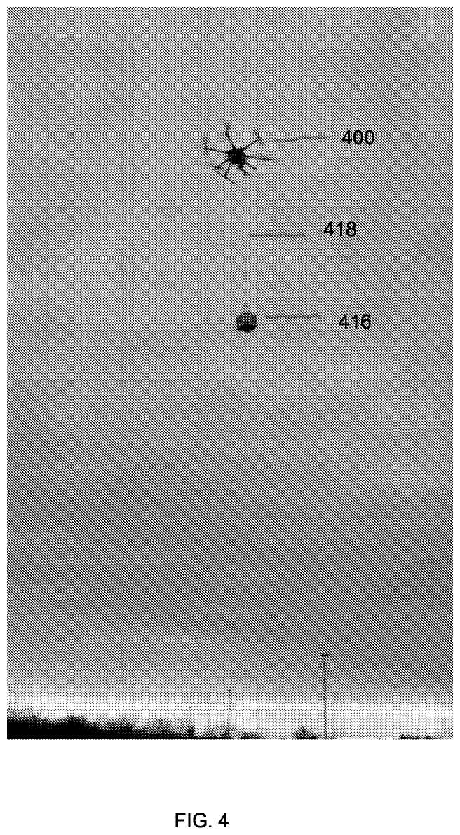

Referring now to FIG. 4, an unmanned helicopter is shown lowering a container 416 using a cord 418. In this example, helicopter 400 comprises six rotors. Cord 418 is at least about 3 meters long but may be at least 30 meters long in other embodiments.

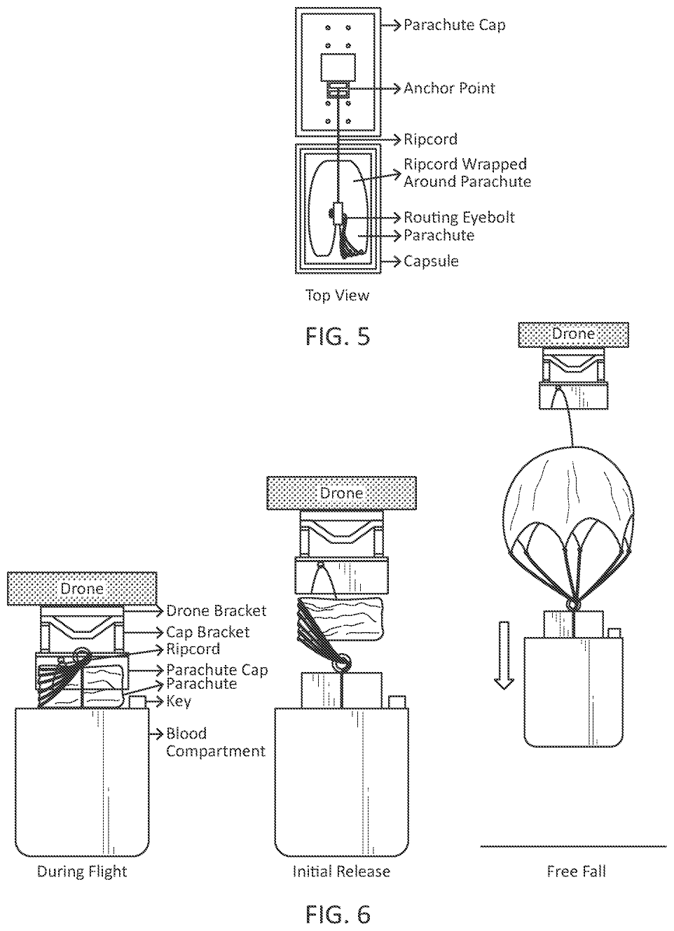

Referring now to FIGS. 5 and 6, an alternative system and method of lowering a container comprising a blood product is shown. According to one method, a large parachute may be deployed to allow blood products to slowly lower towards the ground due to drag./In FIG. 5, a container or capsule is shown housing a parachute and a routing eyebolt coupling the container to the cord or ripcord which, in turn, is coupled to an anchor point on the drone. In this example, a drop mechanism comprises a drone bracket coupled to a parachute cap bracket. In this example, speed limiting is provided by the parachute which is deployed upon the initial release of the container from the drone bracket. In this case, the parachute slows the free fall of the container to the ground at the target location. Parachute cap may be configured to house the parachute to protect it from environmental factors. The release of the container may be controlled by the control circuit within the drone using a latch or other release mechanism configured to let go of the routing eyebolt.

Certain embodiments described herein can omit one or more of the method steps and/or perform the steps in a different order than the order listed. For example, some steps need not be performed in certain embodiments. As a further example, certain steps can be performed in a different temporal order, including simultaneously, than listed above.

While the exemplary embodiments have been described with reference to lowering of blood products, the teachings herein may be applied to lowering other medical products, such as medical devices or machinery (e.g., apheresis devices, etc.) or other devices that are invasive or noninvasive, that interface with a human patient via a needle in the patient's skin, insulin pumps (e.g., for use internal or external to the body cavity), etc. The teachings may also be applied outside the medical field to lower other non-medical objects.

While the embodiments have been described with reference to certain details, it will be understood by those skilled in the art that various changes can be made and equivalents can be substituted without departing from the scope described herein. In addition, many modifications can be made to adapt a particular situation or material to the teachings without departing from its scope. Therefore, it is intended that the teachings herein not be limited to the particular embodiments disclosed, but rather include additional embodiments falling within the scope of the appended claims.

What is claimed is:

1. An unmanned helicopter for delivering a blood product to a target location, comprising:
a body;
a plurality of spinning rotors, each rotor comprising at least one propeller;
a cord coupled to a container configured to contain a blood product;
a drop mechanism configured to lower the cord and blood product and to resist gravitational acceleration of the container during at least a portion of a descent of the container; and
a control circuit configured to navigate the helicopter to the target location and, while airborne, to receive a command to deliver the blood product, the control circuit configured, in response to receiving the command, to control the drop mechanism to lower the cord and container containing the blood product to the target location.

2. The unmanned helicopter of claim 1, wherein the drop mechanism comprises a pulley configured to lower the cord and a passive speed limiter mounted to the pulley and configured to at least partially resist rotation of the pulley while lowering the cord.

3. The unmanned helicopter of claim 1, wherein the drop mechanism is configured to lower the cord and blood product at a velocity between about 0.5 meters per second and about 3 meters per second.

4. The unmanned helicopter of claim 1, further comprising a thermoelectric device configured to use electrical energy to control a temperature of the blood product.

5. The unmanned helicopter of claim 4, wherein the thermoelectric device comprises a Peltier effect device configured to keep the blood product at between about 3 degrees C. and about 30 degrees C.

6. The unmanned helicopter of claim 1, further comprising a wireless communication circuit configured to receive the command to deliver the blood product from a transmitter at or near the target location.

7. The unmanned helicopter of claim 1, further comprising a wireless communication circuit configured to receive the command to deliver the blood product from a command station remote from the target location.

8. The unmanned helicopter of claim 1, wherein the cord has two opposite ends, both of which ends are left at the target location when the blood product is delivered to the target location.

9. The unmanned helicopter of claim 1, wherein the container comprises a vibration mitigation device disposed at a bottom surface of the container, the vibration mitigation device selected from the group comprising a foam, a spring and a pad.

10. A method of delivering a blood product to a target using an unmanned helicopter, comprising:
receiving target location data specifying a geographic location of the target;
navigating the unmanned helicopter to the target using the target location data; receiving a command at the unmanned helicopter to deliver the blood product; and
in response to receiving the command to deliver the blood product, lowering a container containing a blood product from the unmanned helicopter using a cord at one or more controlled speeds.

11. The method of claim 10, wherein the command is initiated from a transmitter at the geographic location.

12. The method of claim 10, wherein the command is initiated from a command station remote from the geographic location.

13. The method of claim 10, further comprising controlling a temperature of the container with a thermoelectric device configured to use electrical energy.

14. The method of claim 13, wherein the temperature is maintained at less than 4 degrees C. during at least a portion of the navigating.

15. The method of claim 10, the cord having two opposite ends, further comprising lowering both ends of the cord to the target.

16. The method of claim 10, wherein the blood product is lowered at a speed less than about 1.5 meters per second for at least half of a distance from the unmanned helicopter to the target.

17. The method of claim 10, further comprising sensing a force imposed on the container and storing the sensed force in a memory circuit in the unmanned helicopter.

18. The method of claim 17, further comprising monitoring a temperature within the compartment during at least a portion of the navigating and storing the monitored temperature in the memory circuit in the unmanned helicopter.

19. The method of claim 10, wherein the lowered container comprises a plurality of blood product containers and disposable transfusion materials comprising needles.

20. A vehicle for delivering a blood product to a target location, comprising:
a motive component;
a cord coupled to a container configured to contain a blood product;
a drop mechanism configured to lower the cord and blood product and to resist gravitational acceleration of the container during at least a portion of a descent of the container; and
a control circuit configured to navigate the vehicle to the target location and, while airborne, to receive a command to deliver the blood product, the control circuit configured, in response to receiving the command, to control the drop mechanism to lower the cord and container containing the blood product to the target location.
